(19) United States
(12) Patent Application Publication
(10) Pub. No.: US 2025/0227578 A1
(43) Pub. Date: Jul. 10, 2025

(54) SYSTEMS AND METHODS FOR MANAGING HANDOVER FOR REDUCED CAPABILITY WIRELESS DEVICES

(71) Applicant: T-Mobile Innovations LLC, Overland Park, KS (US)

(72) Inventors: Mochamad MIRZA, Bothell, WA (US); Liezel REOGANIS, Redmond, WA (US); Hui-Hsia SUNG, Bellevue, WA (US)

(21) Appl. No.: 18/408,975

(22) Filed: Jan. 10, 2024

(51) Int. Cl. H04W 36/08; H04W 36/30

(52) U.S. Cl. CPC H04W 36/08; H04W 36/302

(57) ABSTRACT

Systems and methods are provided for managing handover for reduced capability devices. The methods include determining that one or more available access nodes support reduced capability devices for a handover operation for a reduced capability device. The methods further include measuring a signal strength of the one or more available access node that support reduced capability devices. The methods further include selecting a target access node based in part on the signal strength of the one or more available access nodes that support reduced capability devices. The methods further include moving the reduced capability device to the target access node.

### TECHNICAL BACKGROUND

A wireless network, such as a cellular network, can include an access node (e.g., base station) serving multiple wireless devices or user equipment (UE) in a geographical area covered by a radio frequency transmission provided by the access node. Access nodes may deploy different carriers within the cellular network utilizing different radio access technologies (RATs). RATs can include, for example, 3G RATs (e.g., GSM, CDMA etc.), 4G RATs (e.g., WiMax, LTE, etc.), and 5G RATs (new radio (NR)). RATS may additionally include, for example, Wi-Fi and Bluetooth. Additionally, different standards may be implemented, including one or more International Engineering Task Force (IETF) standards; one or more of the Institute of Electrical and Electronics Engineers (IEEE) 802.11 standards; and/or any other industry standards and/or specifications. Further, different types of access nodes may be implemented for deployment for the various RATs. For example, an evolved NodeB (eNodeB or eNB) may be utilized for 4G RATs and a next generation NodeB (gNodeB or gNB) may be utilized for 5G RATs. Deployment of the evolving RATs in a network provides numerous benefits. For example, newer RATs may provide additional resources to subscribers, faster communications speeds, and other advantages. For example, 5G networks provide edge deployments enabling computing capabilities closer to UEs.

There are times when a wireless device will need to change from one access node to another, such as while moving through coverage areas of various access nodes. This handover from one access node to another can be problematic for reduced capability (RedCap) devices as not all access nodes will be properly configured to handle RedCap devices. A more efficient manner of managing handover in an environment of access nodes that may or may not be properly configured for RedCap devices is needed.

### Overview

Examples described herein include systems and methods for managing handover for reduced capability devices. An exemplary method includes determining that one or more available access nodes support reduced capability devices for a handover operation for a reduced capability device. The method further includes measuring a signal strength of the one or more available access nodes that support reduced capability devices. The method further includes selecting a target access node based in part on the signal strength of the one or more available access nodes that support reduced capability devices. The method further includes moving the reduced capability device to the target access node.

Another exemplary embodiment includes a system including an access node which includes at least one electronic processor configured to perform operations. The operations include determining that one or more available cells support reduced capability devices for a handover procedure for a reduced capability device. The operations further include measuring a signal strength of the one or more available cells that support reduced capability devices. The operations further include selecting a target cell based in part on the signal strength of the one or more available cells that support reduced capability devices. The operations further include moving the reduced capability device to the target cell.

Another exemplary method of managing handover for reduced capability devices includes determining a candidate list of one or more available access nodes for the reduced capability device. The method further includes forming a target list of one or more available access nodes by eliminating from the candidate list of one or more available access nodes any of the one or more available access nodes that do not support reduced capability devices. The method further includes measuring a signal strength of each of the one or more available access nodes on the target list. The method further includes selecting a target access node based in part on the signal strength of the one or more available access nodes on the target list. The method further includes moving the reduced capability device to the target access node.

### BRIEF DESCRIPTION OF THE DRAWINGS

These and other more detailed and specific features of various embodiments are more fully disclosed in the following description, reference being had to the accompanying drawings, in which:

FIG. 1 illustrates an exemplary system for wireless communication in accordance with various aspects of the present disclosure;

FIG. 2 illustrates an exemplary processing node in accordance with various aspects of the present disclosure;

FIG. 3 illustrates an exemplary access node in accordance with various aspects of the present disclosure;

FIG. 4 illustrates an exemplary process flow for managing handover for reduced capability wireless devices; and

FIG. 5 illustrates an exemplary process flow managing handover for reduced capability wireless devices.

### DETAILED DESCRIPTION

In the following description, numerous details are set forth, such as flowcharts, schematics, and system configurations. It will be readily apparent to one skilled in the art that these specific details are merely exemplary and not intended to limit the scope of this application.

In accordance with various aspects of the present disclosure, a wireless network may be provided by an access node. Access nodes provide wireless service to geographic cells. As mobile wireless devices travel around, they move from cell to cell. There is a set handover procedure when a wireless device moves from one cell to another. The handover procedure may also be triggered if there is a significant drop in signal strength or quality between the wireless device and its current access node. A wireless device will continuously measure the signal strength and quality of the access nodes it can communicate with. When the signal strength or quality to the current access node drops low enough and the signal strength or quality to a different neighboring access node is high enough, a handover may be triggered. The network will select a target cell from amongst the cells available to the wireless device and then transfer the wireless device to the target cell.

The handover procedure is not limited to wireless devices that are moving from one cell to another. It could be triggered in other situations, some examples of which follow here. There could an obstruction between the wireless device and its current access node, such as when a user of a smart watch walks next to a tall building that obstructs the signal from one direction. There could be inclement weather form in one direction from the wireless device causing reduced signal strength to access nodes in that direction, but not access nodes in the opposite direction. An access node could go offline, causing all devices connected to handover to different access nodes. A new access node could go online with better signal strength and quality for the wireless device causing it to handover to the new access node.

This handover process works well when all of the access nodes support all of the wireless devices. The handover for reduced capability (RedCap) devices may be more problematic if some of the access nodes are incapable of supporting or are not configured correctly to support RedCap devices. RedCap devices include things like smart watches and other wearables, industrial sensors, and video surveillance equipment, for example. RedCap devices, as the name implies, have less capabilities than typical wireless devices and require less resources from a wireless network to adequately function. They may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for eMBB devices depending on factors including frequency range. For example, 256 QAM is optionally supported for RedCap devices of FR1 DL. FR1 UL, and FR2 UL/DL support 64 QAM.

During handover, when a target cell is chosen for the handover, there are no checks to confirm that the target cell supports RedCap devices. An access node may not support RedCap devices if it is not properly configured to do so. For example, if the access node is not configured to be RedCap device enabled or if it is only configured to accept connections >20 MHz without the option to accommodate RedCap devices via Bandwidth Parts (BWP), a RedCap device will not be able to connect to the access node. During handover for a RedCap device, if the target cell does not support RedCap devices, the handover will still be attempted, and it will then fail during handover preparation with a handover target not allowed error. Once the handover fails, a new target cell will be chosen, which could very well be the same target cell. If the RedCap device is not moving quickly, it is very likely that same cell will have the best signal strength and quality and therefore become the target cell again. This loop will continue until a new cell that supports RedCap devices becomes the target cell and the handover succeeds or eventually the RedCap device may fall back to LTE. During this attempt-failure loop, the RedCap device is using significant extra battery power measuring the signal strength and quality of all of the neighboring cells and attempting handovers that are doomed to fail.

By introducing a new network parameter that indicates whether an access node supports RedCap devices, the attempt-failure loop can be prevented, thus making the handover process for RedCap devices more efficient and avoiding wasting battery life of the RedCap devices. The parameter may be called “isRedCapHoAllowed”, for example, and may indicate for each access node whether it currently supports RedCap devices. For example, the parameter may be set to “Yes” or “1” to indicate the access node supports RedCap devices. It may be set to “No” or “0” to indicate that the access node does not support RedCap devices, for example. The parameter may be manually set, or it may be automatically set if the network determines whether the access node supports RedCap devices. The access node could be checked to see if it is RedCap enabled, if the cell bandwidth is >20 MHz, if the access node allows idle mode cell reselection, or any other relevant criteria that could determine whether the access node supports RedCap devices. Based on an analysis of those criteria, the network could set the parameter for the given access node.

Once the parameter value is determined, it can be used to improve the handover procedure. It can be checked early in the process so that the RedCap device is only measuring the signal strength and quality of access nodes that it would be able to connect to and that operate in the frequency bands it is configured to monitor. Before measuring the signal strength and quality of available cells, the candidate list of available cells can be reduced to a target list by eliminating any cells that do not support RedCap devices. The cells on this smaller target list can be used to determine a target cell for the handover knowing that whichever cell is chosen, the handover will not fail due to a lack of support for RedCap devices. Checking the parameter early can thus prevent attempts to handover to an access node that will never succeed because the access node does not support RedCap devices. If it is determined that none of the available cells support RedCap devices (i.e. the target list is empty), the RedCap device can be instructed to fall back to LTE right away rather than waiting to repeatedly retry connecting to a cell that does not support it.

The method is especially useful for intra-band handovers as there is currently no straightforward way of determining if a cell will support RedCap devices. Even for inter-band handovers, using this new parameter is more straightforward than any current manner of determining if a cell will support RedCap devices.

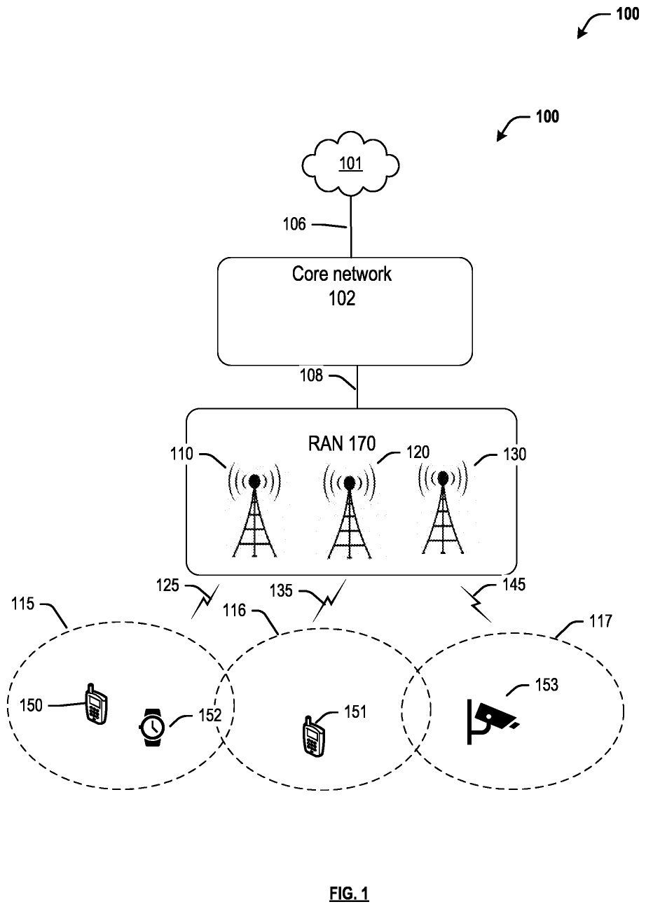

FIG. 1 depicts an exemplary system 100 for wireless communication, in accordance with the disclosed embodiments. The system 100 may include a communication network 101, core network 102, and a radio access network (RAN) 170 including access nodes 110, 120, and 130. The RAN 170 may include other devices and additional access nodes. Although three access nodes are shown, any number of access nodes may be included.

The system 100 also includes multiple wireless devices 150-153, which may be end-user wireless devices and may operate within one or more coverage areas 115, 116, and 117. The wireless devices 150-153 communicate with access nodes 110, 120, and/or 130 within the RAN 170 over communication links 125, 135, and 145, which may for example be 5G NR communication links, 4G LTE communication links, or any other suitable type of communication link.

Access nodes 110, 120, and 130 can be, for example, standard access nodes such as a macro-cell access node, a base transceiver station, a radio base station, an eNodeB device, an enhanced eNodeB device, a next generation NodeB (or gNodeB) in 5G New Radio (“5G NR”), or the like. In additional embodiments, access nodes may comprise two co-located cells, or antenna/transceiver combinations that are mounted on the same structure. Alternatively, access nodes may comprise a short range, low power, small-cell access node such as a microcell access node, a picocell access node, a femtocell access node, or a home eNodeB device.

The access nodes can comprise a processor and associated circuitry to execute or direct the execution of computer-readable instructions to perform operations such as those further described herein. Access nodes can retrieve and execute software from storage, which can include a disk drive, a flash drive, memory circuitry, or some other memory device, and which can be local or remotely accessible. The software comprises computer programs, firmware, or some other form of machine-readable instructions, and may include an operating system, utilities, drivers, network interfaces, applications, or some other type of software, including combinations thereof.

Each of wireless devices 150-153 may be capable of simultaneously communicating with the RAN 170 using combinations of antennae via 4G and 5G or any other RAT or transmission mode, including multiple carriers. For instance, MU-MIMO pairings and SU-MIMO pairings can be made by wireless devices 150-153. It is noted that any number of access nodes, antennae, MU-MIMO pools, carriers, and wireless devices can be implemented.

Wireless devices 150-153 may be any device, system, combination of devices, or other such communication platform capable of communicating on the wireless network using one or more frequency bands deployed therefrom. Wireless devices 150-153 may be divided into two categories for the purposes of this disclosure. Wireless devices 150-151 may be normal capability devices and may be, for example, mobile phones, wireless phones, cellular home internet modems, personal digital assistants (PDA), tablet computers, as well as other types of devices or systems that can exchange audio or data via the wireless network as non-reduced capability devices. Wireless devices 152-153 may be reduced capability (RedCap) devices and may include smart watches and other wearables, industrial sensors, and video surveillance equipment, for example. Other types of communication platforms are possible.

A wireless device 150-153 may be considered a reduced capability device 152-153 if its network requirements are lower than typical wireless devices 150-151. For example, RedCap devices 152-153 may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for non-reduced capability devices 150-151 depending on factors including frequency range. For example, 256 QAM is optionally supported for RedCap devices of FR1 DL. FR1 UL, and FR2 UL/DL support 64 QAM.

In operation, system 100 may be configured to execute a method including determining that a reduced capability device 152-153 should perform a handover procedure to connect to a different access node 110, 120, 130. The method further includes determining that one or more available access nodes 110, 120, 130 support reduced capability devices 152-153 for a handover operation for the reduced capability device 152-153. This may be accomplished by checking a RedCap parameter for each of the available access nodes 110, 120, 130 where the parameter indicates whether or not the corresponding access node 110, 120, 130 supports reduced capability devices 152-153. This RedCap parameter may be manually set, or it may be set automatically after the system analyzes the state of the access node 110, 120, 130. For example, one or more of the following may be analyzed to determine if the access node 110, 120, 130 supports reduced capability devices 152-153: whether the one or more available access nodes 110, 120, 130 is reduced capability device enabled, whether the one or more available access nodes 110, 120, 130 is restricted to bandwidth greater than 20 MHz, and whether idle mode cell reselection is allowed for the one or more available access nodes 110, 120, 130.

The method further includes measuring a signal strength of the one or more available access nodes 110, 120, 130 that support reduced capability devices 152-153. The method further includes selecting a target access node 110, 120, 130 based in part on the signal strength of the one or more available access nodes 110, 120, 130 that support reduced capability devices. The method further includes moving the reduced capability device 152-153 to the target access node 110, 120, 130. If it is determined that none of the available access nodes 110, 120, 130 support reduced capability devices 152-153, the reduced capability device 152-153 may be instructed to fall back to an LTE connection. The above method can be performed when the reduced capability device 152-153 is on the same frequency as the available access nodes 110, 120, 130 or when they are on different frequencies.

System 100 may further include many components not specifically shown in FIG. 1 including processing nodes, controller nodes, routers, gateways, and physical and/or wireless data links for communicating signals among various network elements. System 100 may include one or more of a local area network, a wide area network, and an internetwork (including the Internet). System 100 may be capable of communicating signals and carrying data, for example, to support voice, push-to-talk, broadcast video, and data communications by end-user wireless devices 150-153. Wireless network protocols may include one or more of Multimedia Broadcast Multicast Services (MBMS), code division multiple access (CDMA) 1×RTT (radio transmission technology), Global System for Mobile communications (GSM), Universal Mobile Telecommunications System (UMTS), High-Speed Packet Access (HSPA), Evolution Data Optimized (EV-DO), Worldwide Interoperability for Microwave Access (WiMAX), Third Generation Partnership Project Long Term Evolution (3GPP LTE), Fourth Generation broadband cellular (4G, LTE Advanced, etc.), and Fifth Generation mobile networks or wireless systems (5G, 5G New Radio (“5G NR”), or 5G LTE). Wired network protocols utilized by communication network 101 may include one or more of Ethernet, Fast Ethernet, Gigabit Ethernet, Local Talk (such as Carrier Sense Multiple Access with Collision Avoidance), Token Ring, Fiber Distributed Data Interface (FDDI), and Asynchronous Transfer Mode (ATM).

Other network elements may be present in system 100 to facilitate communication but are omitted for clarity, such as base stations, base station controllers, mobile switching centers, dispatch application processors, and location registers such as a home location register or visitor location register. Furthermore, other network elements that are omitted for clarity may be present to facilitate communication, such as additional processing nodes, routers, gateways, and physical and/or wireless data links for carrying data among the various network elements.

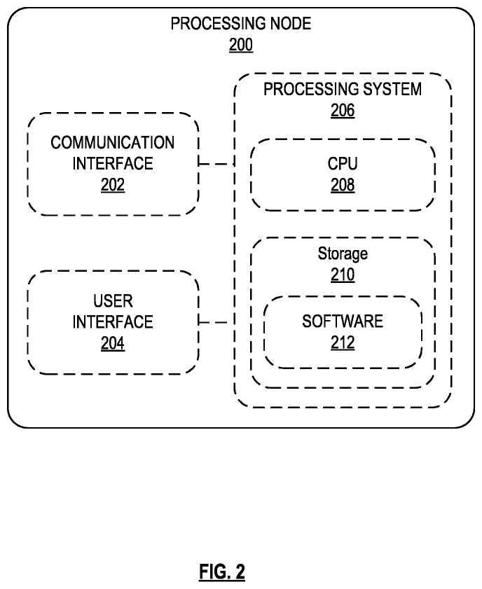

FIG. 2 depicts an exemplary processing node 200, which may be configured to perform the methods and operations disclosed herein to manage handover of reduced capability devices. The processing node 200 includes a communication interface 202, user interface 204, and processing system 206 in communication with communication interface 202 and user interface 204. Processing system 206 includes a processor 208, storage 210, which can comprise a disk drive, flash drive, memory circuitry, or other memory device including, for example, a buffer. Storage 210 can store software 212 which is used in the operation of the processing node 200. Software 212 may include computer programs, firmware, or some other form of machine-readable instructions, including an operating system, utilities, drivers, network interfaces, applications, or some other type of software. Processing system 206 may include a microprocessor 208 and other circuitry to retrieve and execute software 212 from storage 210. Processing node 200 may further include other components such as a power management unit, a control interface unit, etc., which are omitted for clarity. Communication interface 202 permits processing node 200 to communicate with other network elements. User interface 204 permits the configuration and control of the operation of processing node 200.

In an exemplary embodiment, software 212 can include instructions for determining that a reduced capability device should perform a handover procedure to connect to a different access node. The operations further include determining that one or more available access nodes support reduced capability devices for a handover procedure for a reduced capability device. This may be accomplished by checking a RedCap parameter for each of the available access nodes where the parameter indicates whether or not the corresponding access node supports reduced capability devices. This RedCap parameter may be manually set, or it may be set automatically after the system analyzes the state of the access node. For example, one or more of the following may be analyzed to determine if the access node supports reduced capability devices: whether the one or more available access nodes is reduced capability device enabled, whether the one or more available access is restricted to bandwidth greater than 20 MHz, and whether idle mode cell reselection is allowed for the one or more available access nodes.

The operations further include measuring a signal strength of the one or more available access nodes that support reduced capability devices. The operations further include selecting a target access node based in part on the signal strength of the one or more available access nodes that support reduced capability devices. The operations further include moving the reduced capability device to the target access node. If it is determined that none of the available access nodes support reduced capability devices, the reduced capability device may be instructed to fall back to an LTE connection. The above method can be performed when the reduced capability device is on the same frequency as the available access nodes or when they are on different frequencies.

A wireless device may be considered a reduced capability device if its network requirements are lower than typical non-reduced capability devices. For example, reduced capability devices may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for non-reduced capability devices depending on factors including frequency range. For example, 256 QAM is optionally supported for RedCap devices of FR1 DL. FR1 UL, and FR2 UL/DL support 64 QAM.

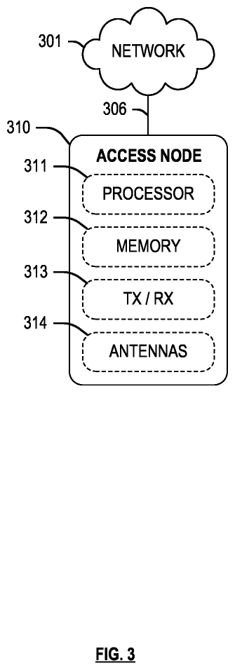

FIG. 3 depicts an exemplary access node 310 for providing wireless service in wireless networks. Access node 310 is configured as an access point for providing network services from network 301 to end-user wireless devices such as wireless devices 150-153 in FIG. 1. Access node 310 is illustrated as comprising a processor 311, a memory 312 for storing logical modules that perform operations described herein, and one or more transceivers 313 for transmitting and receiving signals via antennae 314. Combination of antennae 314 and transceivers 313 are configured to deploy one or more radio air interfaces using different RATs, frequencies, and/or operating modes. Additional transceivers and antennae may be incorporated in order to deploy 4G, 5G, mm-wave, SU-MIMO, MU-MIMO or massive MU-MIMO data streams to wireless devices attached to access node 310, as well as to facilitate communication with other network nodes on network 301. Further, access node 310 is communicatively coupled to network 301 via communication interface 306, which may be any wired or wireless link as described above. The one or more antennae 314 can include any combination of: antennae associated with different radio access technologies (RATs) (including 3G, 4G, 5G, 5G sub 6G, 5G millimeter wave), antennae associated with different arrays (including 2×2, 4×2, 4×4, 8×8, 16×16, 32×32, 64×64, 128×128, and so on), and beamforming antennae.

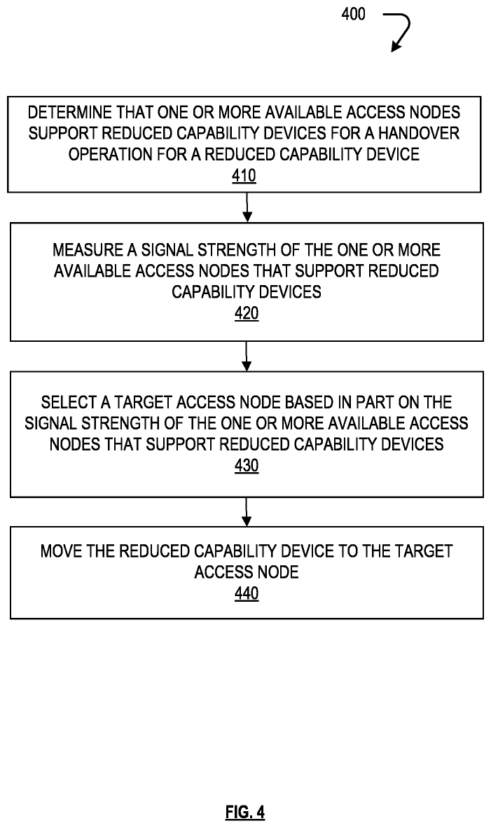

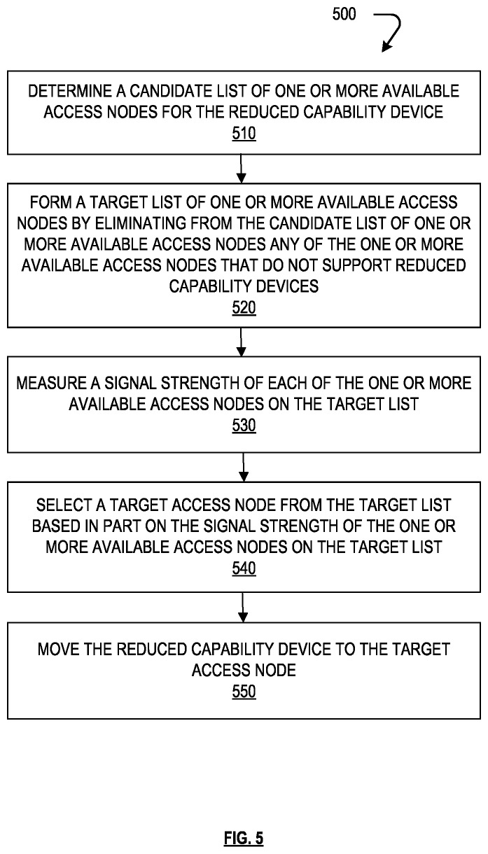

Access node 310 may be configured to perform the methods described herein including the methods described with respect to FIG. 4 and FIG. 5. The processor 311 of access node 310 may be configured to perform the instructions described herein including those described with respect to the processing node 200 of FIG. 2.

FIG. 4 illustrates an exemplary method 400 for managing handover for reduced capability wireless devices. Method 400 can be implemented by any suitable combination of processors, such as processing node 200. Although FIG. 4 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 400 begins in step 410 where it is determined that one or more available access nodes support reduced capability devices for a handover operation for a reduced capability device. This may be accomplished by checking a RedCap parameter for each of the available access nodes where the parameter indicates whether or not the corresponding access node supports reduced capability devices. This RedCap parameter may be manually set, or it may be set automatically after the system analyzes the state of the access node. For example, one or more of the following may be analyzed to determine if the access node supports reduced capability devices: whether the one or more available access nodes is reduced capability device enabled, whether the one or more available access is restricted to bandwidth greater than 20 MHz, and whether idle mode cell reselection is allowed for the one or more available access nodes.

Method 400 continues in step 420 where a signal strength of the one or more available access nodes that support reduced capability devices is measured. Method 400 continues in step 430 where a target access node is selected based in part on the signal strength of the one or more available access nodes that support reduced capability devices. Method 400 continues in step 440 where the reduced capability devices is moved to the target access node. If it is determined that none of the available access nodes support reduced capability devices, the reduced capability device may be instructed to fall back to an LTE connection. The above method can be performed when the reduced capability device is on the same frequency as the available access nodes or when they are on different frequencies.

A wireless device may be considered a reduced capability device if its network requirements are lower than typical non-reduced capability devices. For example, reduced capability devices may be characterized by having a maximum bandwidth of 100 MHz or 20 MHz depending on which frequency range they are operating on. For example, 100 MHz is supported on Frequency Range 2 (FR2) and 20 MHz is supported on Frequency Range 1 (FR1). They may also be limited to one or two Rx branches with either one or two MIMO layers being supported, respectively. They also could have a maximum modulation order of 64 QAM rather than the 256 QAM for non-reduced capability devices depending on factors including frequency range. For example, 256 QAM is optionally supported for RedCap devices of FR1 DL. FRI UL, and FR2 UL/DL support 64 QAM.

FIG. 5 illustrates an exemplary method 500 for managing handover for a reduced capability wireless device. Method 500 can be implemented by any suitable combination of processors, such as processing node 200. Although FIG. 5 depicts steps performed in a particular order for purposes of illustration and discussion, the operations discussed herein are not limited to any particular order or arrangement. One skilled in the art, using the disclosures provided herein, will appreciate that various steps of the methods can be omitted, rearranged, combined, and/or adapted in various ways.

Method 500 begins in step 510 where a candidate list of one or more available access nodes for the reduced capability device is determined. Method 500 continues in step 520 where a target list of one or more available access nodes is formed by eliminating from the candidate list of one or more available access nodes any of the one or more available access nodes that do not support reduced capability devices. Method 500 continues in step 530 where a signal strength of each of the one or more available access nodes on the target list is measured. Method 500 continues in step 540 where a target access node is selected from the target list based in part on the signal strength of the one or more available access nodes on the target list. Method 500 continues in step 550 where the reduced capability device is moved to the target access node. Method 500 may have the optional step of determining that the reduced capability device should perform a handover operation to connect to a different access node.

It may be determined that the one or more available access nodes supports reduced capability devices by checking a RedCap parameter for each of the available access nodes where the parameter indicates whether or not the corresponding access node supports reduced capability devices. This RedCap parameter may be manually set, or it may be set automatically after the system analyzes the state of the access node. For example, one or more of the following may be analyzed to determine if the access node supports reduced capability devices: whether the one or more available access nodes is reduced capability device enabled, whether the one or more available access is restricted to bandwidth greater than 20 MHz, and whether idle mode cell reselection is allowed for the one or more available access nodes.

If it is determined that none of the available access nodes support reduced capability devices, the reduced capability device may be instructed to fall back to an LTE connection. The above method can be performed when the reduced capability device is on the same frequency as the available access nodes or when they are on different frequencies.

In some embodiments, methods 400 and 500 may include additional steps or operations. Furthermore, the methods may include steps shown in each of the other methods. As one of ordinary skill in the art would understand, the methods of 400 and 500 may be integrated in any useful manner and the steps may be performed in any useful sequence.

The exemplary systems and methods described herein can be performed under the control of a processing system executing computer-readable codes embodied on a computer-readable recording medium or communication signals transmitted through a transitory medium. The computer-readable recording medium is any data storage device that can store data readable by a processing system, and includes both volatile and nonvolatile media, removable and non-removable media, and contemplates media readable by a database, a computer, and various other network devices.

Examples of the computer-readable recording medium include, but are not limited to, read-only memory (ROM), random-access memory (RAM), erasable electrically programmable ROM (EEPROM), flash memory or other memory technology, holographic media or other optical disc storage, magnetic storage including magnetic tape and magnetic disk, and solid-state storage devices. The computer-readable recording medium can also be distributed over network-coupled computer systems so that the computer-readable code is stored and executed in a distributed fashion. The communication signals transmitted through a transitory medium may include, for example, modulated signals transmitted through wired or wireless transmission paths.

The above description and associated figures teach the best mode of the invention. The following claims specify the scope of the invention. Note that some aspects of the best mode may not fall within the scope of the invention as specified by the claims. Those skilled in the art will appreciate that the features described above can be combined in various ways to form multiple variations of the invention. As a result, the invention is not limited to the specific embodiments described above, but only by the following claims and their equivalents.

What is claimed is:

1. A method of managing handover for a reduced capability device, the method comprising:
determining that one or more available access nodes support reduced capability devices for a handover operation for the reduced capability device;
measuring a signal strength of the one or more available access nodes that support reduced capability devices;
selecting a target access node based in part on the signal strength of the one or more available access nodes that support reduced capability devices; and
moving the reduced capability device to the target access node.

2. The method of claim 1, wherein determining that the one or more available access nodes support reduced capability devices comprises:
determining that a RedCap parameter indicates that the one or more available access nodes is capable of supporting reduced capability devices.

3. The method of claim 2, wherein the RedCap parameter is manually set.

4. The method of claim 2, wherein the RedCap parameter is automatically set based on an analysis of one or more of: whether the one or more available access nodes is reduced capability device enabled, whether the one or more available access nodes is restricted to bandwidth greater than 20 MHz, and whether idle mode cell reselection is allowed for the one or more available access nodes.

5. The method of claim 1, wherein the one or more available access nodes are on a same frequency as the reduced capability device.

6. The method of claim 1, the method further comprising:
upon determining that none of the one or more available access nodes support reduced capability devices, instructing the reduced capability device to fall back to an LTE connection.

7. The method of claim 1, wherein the reduced capability device has a maximum bandwidth of 20 MHz.

8. A system, the system comprising:
an access node including at least one electronic processor configured to perform operations, the operations comprising:
determining that one or more available access nodes support reduced capability devices for a handover procedure for a reduced capability device;
measuring a signal strength of the one or more available access nodes that support reduced capability devices;
selecting a target access node based in part on the signal strength of the one or more available access nodes that support reduced capability devices; and
moving the reduced capability device to the target access node.

9. The system of claim 8, wherein determining that the one or more available access nodes support reduced capability devices comprises:
determining that a RedCap parameter indicates that the one or more available access nodes is capable of supporting reduced capability devices.

10. The system of claim 9, wherein the RedCap parameter is manually set.

11. The system of claim 9, wherein the RedCap parameter is automatically set based on an analysis of one or more of: whether the one or more available access nodes is reduced capability device enabled, whether the one or more available access nodes is restricted to bandwidth greater than 20 MHz, and whether idle mode cell reselection is allowed for the one or more available access nodes.

12. The system of claim 8, wherein the one or more available access nodes are on a same frequency as the reduced capability device.

13. The system of claim 8, wherein the operations further comprise:
upon determining that none of the one or more available access nodes support reduced capability devices, instructing the reduced capability device to fall back to an LTE connection.

14. The system of claim 8, wherein the reduced capability device has a downlink limited to a maximum of 2 MIMO layers.

15. A method of managing handover for a reduced capability device, the method comprising:
determining a candidate list of one or more available access nodes for the reduced capability device;
forming a target list of one or more available access nodes by eliminating from the candidate list of one or more available access nodes any of the one or more available access nodes that do not support reduced capability devices;
measuring a signal strength of each of the one or more available access nodes on the target list;
selecting a target access node from the target list based in part on the signal strength of the one or more available access nodes on the target list; and
moving the reduced capability device to the target access node.

16. The method of claim 15, the method further comprising:
determining that the reduced capability device should perform a handover operation to connect to a different access node.

17. The method of claim 15, wherein one or more of the available access nodes do not support reduced capability devices if a RedCap parameter indicates that the one or more available access nodes is incapable of supporting reduced capability devices.

18. The method of claim 17, wherein the RedCap parameter is manually set.

19. The method of claim 17, wherein the RedCap parameter is automatically set based on an analysis of one or more of: whether the one or more available access nodes is reduced capability device enabled, whether the one or more available access nodes is restricted to bandwidth greater than 20 MHz, and whether idle mode cell reselection is allowed for the one or more available access nodes.

20. The method of claim 15, the method further comprising:
upon determining that none of the one or more available access nodes support reduced capability devices, instructing the reduced capability device to fall back to an LTE connection.
